(19) United States
(12) Patent Application Publication
(10) Pub. No.: US 2025/0098014 A1
(43) Pub. Date: Mar. 20, 2025

(54) Method for Conditional Mobility

(71) Applicant: ZTE Corporation, Shenzhen (CN)

(72) Inventors: Mengjie ZHANG, Shenzhen (CN); Zijiang MA, Shenzhen (CN); He HUANG, Shenzhen (CN); Jing LIU, Shenzhen (CN)

(73) Assignee: ZTE Corporation, Shenzhen (CN)

(21) Appl. No.: 18/962,289

(22) Filed: Nov. 27, 2024

Related U.S. Application Data
(63) Continuation of application No. PCT/CN2022/110674, filed on Aug. 5, 2022.

(51) Int. Cl. H04W 76/20; H04W 36/08; H04W 36/36

(52) U.S. Cl. CPC H04W 76/20; H04W 36/08; H04W 36/362

(57) ABSTRACT

This document is directed generally to wireless communications and more specifically to an improvement in handling conditional mobility of wireless terminals. For example, the various implementations disclosed herein help provide an inter-node interaction procedure between master access network nodes (MNs) and secondary access network nodes (MNs) when conditional handover (CHO) and/or conditional PScell addition/change (CPAC) procedure is configured. Example mechanisms are provided for an SN to inform an MN about the execution of secondary cell group (SCG) reconfiguration/update and to provide updated SCG configuration to the MN.

### TECHNICAL FIELD

This document is directed generally to wireless communications and more specifically to an improved handling of mobility of wireless terminals.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document is directed generally to wireless communications and more specifically to an improvement in handling conditional mobility of wireless terminals. For example, the various implementations disclosed herein help provide an inter-node interaction procedure between master access network nodes (MNs) and secondary access network nodes (MNs) when conditional handover (CHO) and/or conditional PSCell addition/change (CPAC) procedure is configured. Example mechanisms are provided for an SN to inform an MN about the execution of secondary cell group (SCG) reconfiguration/update and to provide updated SCG configuration to the MN.

In some implementations, a method for wireless communication is disclosed. The method may include comprising sending a request message comprising an indication of an execution of a Secondary Cell Group (SCG) reconfiguration; and receiving a response message associated with the request message.

In the implementations above, sending the request message may include sending the request message from a secondary wireless communication node (SN) to a master wireless communication node (MN), and wherein the response message is received by the SN from the MN.

In any one of the implementations above, the request message comprises an SN modification request message, and wherein the response message comprises an SN modification response message.

In any one of the implementations above, the request message comprises a new SCG configuration, and wherein the new SCG configuration is contained in an SN to MN container.

In any one of the implementations above, the method may further include causing the MN to treat the new SCG configuration as having already been applied in the user equipment (UE) and not to forward the new SCG configuration to the UE.

In any one of the implementations above, the execution of SCG reconfiguration may include at least one of: an execution of an SN initiated intra-SN conditional PSCell change (CPC) procedure; or an execution of an RRC reconfiguration using signaling radio bearer (SRB) 3.

In any one of the implementations above, the execution of an SN initiated intra-SN CPC causes the MN to consider that a conditional reconfiguration, if configured in the UE, has been released due to execution of an SN initiated intra-SN CPC.

In any one of the implementations above, the conditional reconfiguration may include at least one of the following: a conditional handover (CHO); a conditional PSCell addition (CPA); an MN initiated conditional PSCell change (CPC); or an SN initiated inter-SN CPC, or an SN initiated intra-SN CPC.

In some other implementations, another method for wireless communication is disclosed, the method may include receiving a request message comprising an indication of an execution of Secondary Cell Group (SCG) reconfiguration; and transmitting a response message associated with the request message.

In the implementations above, receiving the request message comprises receiving the request message by a master wireless communication node (MN) from a secondary wireless communication node (SN), and wherein the response message is transmitted by the MN to the SN.

In any one of the implementations above, the request message comprises an SN modification request message, and wherein the response message comprises an SN modification response message.

In any one of the implementations above, the request message comprises a new SCG configuration, and wherein the new SCG configuration is contained in an SN to MN container.

In any one of the implementations above, the method may further include treating the new SCG configuration as having already been applied in the user equipment (UE) and not to forward the new SCG configuration to the UE.

In any one of the implementations above, the execution of SCG may include at least one of: an execution of an SN initiated intra-SN conditional PSCell change (CPC) procedure; or an execution of an RRC reconfiguration using signaling radio bearer (SRB) 3.

In any one of the implementations above, the execution of an SN initiated intra-SN CPC causes the MN to consider that a conditional reconfiguration, if configured in the UE, has been released due to execution of an SN initiated intra-SN CPC.

In any one of the implementations above, the conditional reconfiguration may include at least one of the following: a conditional handover (CHO); a conditional PSCell addition (CPA); an MN initiated conditional PSCell change (CPC); or an SN initiated inter-SN CPC, or an SN initiated intra-SN CPC.

In some other implementations, a wireless communications apparatus is disclosed. The wireless communication apparatus may include a processor and a memory, wherein the processor is configured to read code from the memory and implement any one of the methods above.

In yet some other implementations, a non-transitory computer readable medium is disclosed. The non-transitory computer readable medium may include computer instructions, when executed by a processor of a wireless communication device, may cause the wireless communication device to implement any one of the methods above.

### BRIEF DESCRIPTION OF THE DRAWINGS

FIG. 1 shows an example base station.

FIG. 2 shows an example random access (RA) messaging environment.

FIG. 3 shows a Master Node (MN) initiated Conditional PSCell addition/change (CPAC) procedure according to an embodiment of the present disclosure.

FIG. 4 shows one embodiment of communications for a Master Node (MN) and a Secondary Node (SN).

FIG. 5 shows another embodiment of communications for a Master Node (MN) and a Secondary Node (SN).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random-Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications, and other examples, including but not limited to RACH, are also possible. The wireless communications described herein may be through radio access.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell. The mobility between cells described in these embodiments may be based on the PCell, PSCell, and/or SCell. However, as described in this disclosure, they may be referred to as a source cell and a target cell. A user equipment (“UE”) device may move between nodes or cells in which case a handover or a change/addition operation may occur to improve network reliability for the UE as it moves from a source cell to a target cell.

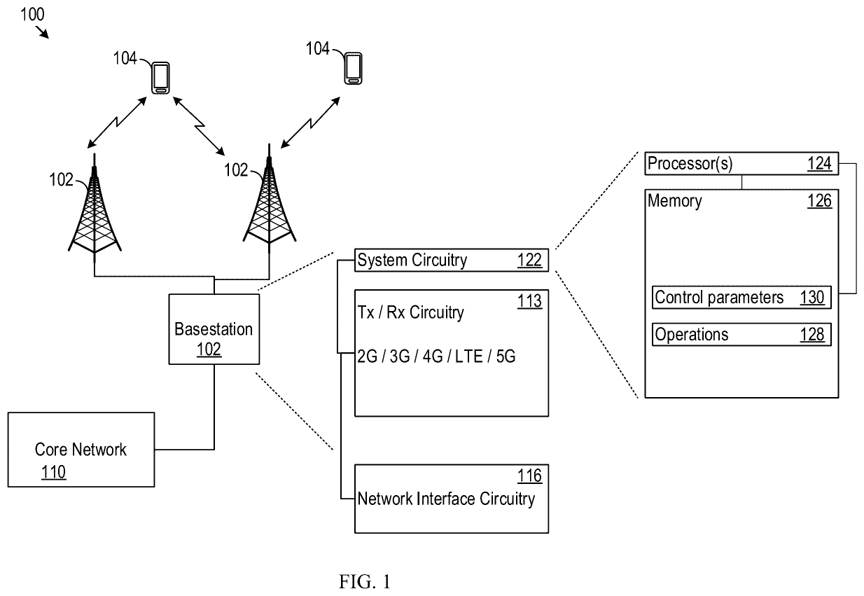

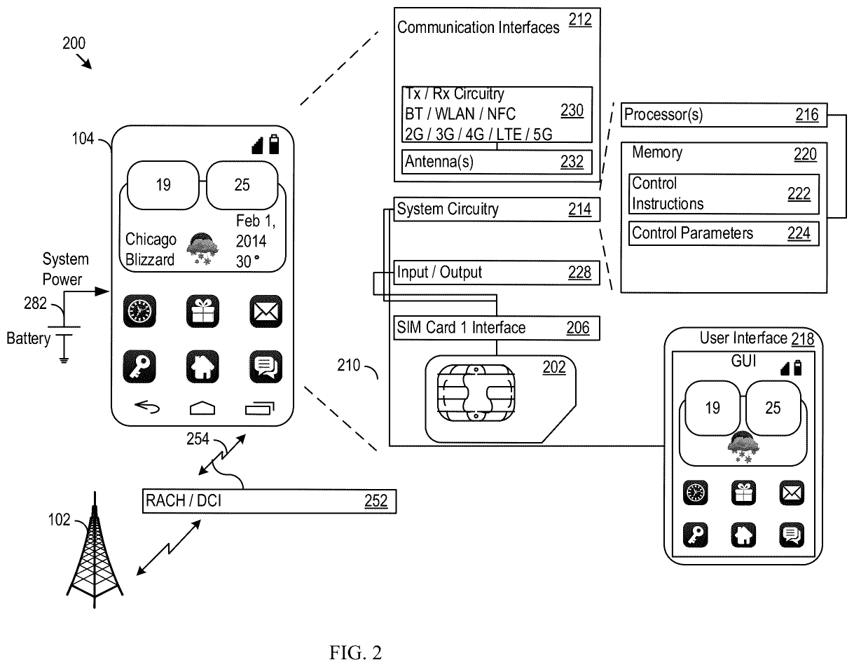

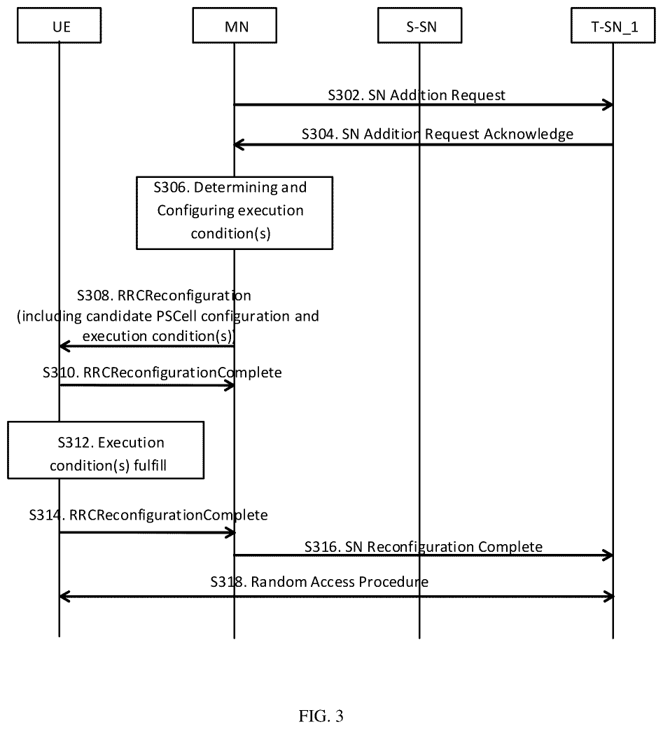

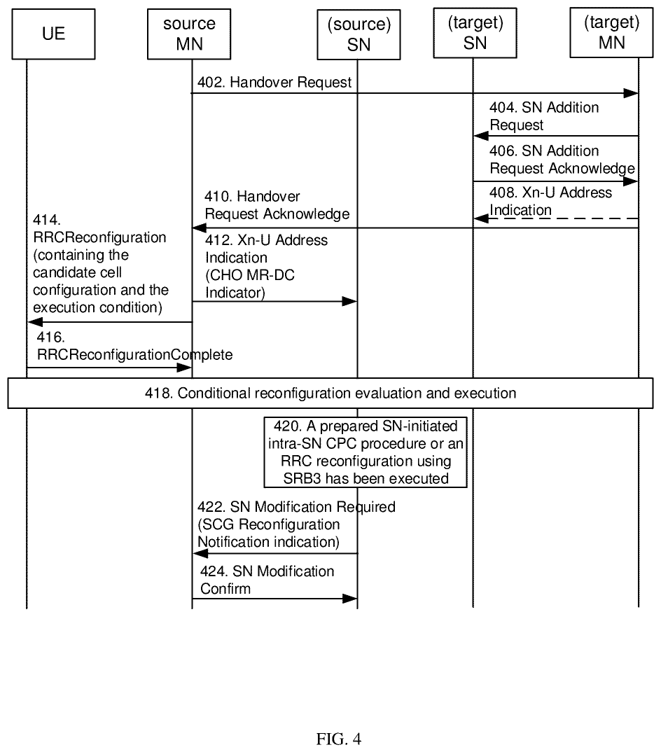

As described below with respect to FIGS. 1-2, a network provider may include a number of network nodes (i.e., base stations) for providing network access to a user equipment (“UE”) device. The network nodes are referred to as base stations in some embodiments. FIGS. 3-4 illustrate examples for the MN/SN communications for achieving UE mobility.

FIG. 1 shows an example base station 102. The base station may also be referred to as a wireless network node and may be the network nodes (e.g., master node (“MN”), secondary node (“SN”), and the source/target nodes) shown in FIGS. 3-5. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. The system circuitry 122 may include processor(s) 124 and/or memory 126. Memory 126 may include operations 128 and control parameters 130 (collectively referred to as instructions and data). Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random-access messaging environment, a UE 104 may communicate with a base station 102 over a random access channel 252. In this example, the UE 104 supports one or more Subscriber Identity Modules (SIMs), such as the SIM 1 202. Electrical and physical interface 206 connects SIM 1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g., eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may be the control plane entities and User Plane Function (“UPF”) may represent the user plane entity in new radio (“NR”) or 5GC. The signaling connection between AMF/SMF and the master node (“MN”) may be a Next Generation-Control Plane (“NG-C”)/MN interface. The signaling connection between MN and SN may be an Xn-Control Plane (“Xn-C”) interface. The signaling connection between MN and UE may be a Uu-Control Plane (“Uu-C”) RRC interface. All these connections manage the configuration and operation of MR-DC. The user plane connection between User Plane Function (“UPF”) and MN may be NG-U (MN) interface instance.

To reduce interruption time and improve mobility reliability (i.e., mobility robustness) in SN change or SN addition, a Conditional PSCell Addition/Change (CPAC) is promoted. The CPAC is defined as a PSCell addition/change that is executed by the UE when execution condition(s) is met. The UE starts evaluating the execution condition(s) upon receiving the CPAC configuration, and stops evaluating the execution condition(s) once the PSCell addition/change is triggered. The CPAC configuration includes the candidate PSCell configuration (including SCG configuration generated by the candidate SN and possibly MCG configuration generated by the MN) and the corresponding execution condition(s) for the candidate PSCell.

The CPAC procedure can be triggered by either the MN or the SN, so it can be categorized as MN initiated CPAC or SN initiated CPAC. In addition, the CPAC procedure can be involved with MN or without MN, so it can be classified as CPAC with MN involvement or CPAC without MN involvement (i.e., intra-SN CPC (Conditional PSCell Change) without MN involvement) as well.

FIG. 3 illustrates the MN initiated CPAC procedure according to an embodiment of the present disclosure. In this case, the execution condition(s) is decided by the MN. The source SN is denoted as S-SN, and the target SN or the candidate SN is denoted as T-SN_1.

S302. The MN sends an SN addition request message to the target SN. In this SN addition request message, the MN may include measurement results related to the target SN and a CPAC indication to indicate that it is a conditional based procedure.

S304. The target SN responds an SN addition request acknowledgment to the MN, including the candidate PSCell(s) configuration.

S306. The MN determines the execution condition(s) for the candidate PSCell.

S308. The MN sends an RRCReconfiguration message including a CPAC configuration to the UE. The CPAC configuration includes at least the candidate PSCell configuration (i.e., an RRCReconfiguration message generated by the target SN) and the corresponding execution condition(s).

S310. The UE replies to an RRCReconfigurationComplete message to the MN to confirm the reception of the RRCReconfiguration message.

S312. The UE keeps connection with the source SN and starts evaluating the execution condition(s). When at least one execution condition for the candidate PSCell is met, the UE selects the related cell as the target PSCell and triggers the execution of CPAC to access to the target SN.

S314. At the execution of CPAC, the UE sends an RRCReconfigurationComplete message to the MN. The RRCReconfigurationComplete for the MN message includes an embedded RRCReconfigurationComplete for the target SN.

S316. The MN transfers the SN Reconfiguration Complete message (i.e., the embedded RRCReconfigurationComplete) to the target SN.

S318. The UE performs a Random Access (RA) procedure towards the target PSCell of the SN. Note that the order the UE sends the RRCReconfigurationComplete message and performs the Random-Access procedure towards the SCG is not limited (i.e., the order of S314, S316 and S318 is not defined and/or can be changed).

For the SN initiated CPC procedure with MN involvement (e.g., SN initiated inter-SN CPC), the execution condition(s) is decided by the SN. The procedure is similar to MN initiated CPAC procedure except that the source SN firstly sends an SN change required message to the MN to request the initiation of the conditional SN change procedure. Besides, in this embodiment, the SN change required message may include the execution condition(s) generated by the source SN.

In the SN initiated CPC without MN involvement (e.g., SN initiated intra-SN CPC), the SN can send the RRCReconfiguration including CPC configurations to the UE via SRB3 directly if SRB3 is configured. SRB3 is a signaling radio bearer between the UE and the SN. In a different embodiment, the SN sends the RRCReconfiguration to the MN, and the MN transfers the message to the UE transparently.

To reduce the handover interruption time and improve the mobility reliability (i.e., mobility robust), Conditional Handover (CHO) is promoted. The CHO is defined as a handover that is executed by the UE when execution condition(s) is met. The UE starts evaluating the execution condition(s) upon receiving the CHO configuration, and stops evaluating the execution condition(s) once handover is triggered. The CHO configuration includes the candidate primary cell (PCell) configuration generated by the candidate node and the corresponding execution condition(s) for the candidate cell. In a different embodiment, CHO is applicable to MR-DC case (i.e., CHO with MR-DC case). The CHO configuration includes the CHO candidate cell configuration generated by the candidate MN and the candidate SN, and the corresponding execution condition(s) for the candidate cell. The CHO candidate cell configuration includes MCG configuration generated by the candidate MN and SCG configuration generated by the candidate SN.

CHO and CPAC can be referred to a conditional reconfiguration. Namely, the conditional reconfiguration includes CHO, CPA, MN initiated CPC, SN initiated inter-SN CPC, SN initiated intra-SN CPC, etc.

Details of the present disclosure are described in the aspects below, but the present disclosure is not limited thereto.

In CHO with MR-DC case or CPC case, the candidate cell configuration may include the delta configuration based on the source SCG configuration. When SN initiated SN modification procedure without MN involvement is preformed (e.g. a prepared SN-initiated intra-SN CPC procedure or an RRC Reconfiguration using SRB3 has been executed), the MN will lose the latest SCG configuration. The MN should know the updated/new SCG configuration. And then the MN can trigger the CHO/CPAC cancellation to release the CHO/CPAC configuration, or trigger the CHO/CPAC modification to update the candidate cell configuration based on the new SCG configuration, if needed.

Under coexistence of CHO and CPAC (including CPA, MN initiated inter-SN CPC, SN initiated inter-SN CPC, SN initiated intra-SN CPC), CHO (including CHO with MR-DC) and CPAC can be configured for the UE simultaneously. When one conditional reconfiguration is executed, the other conditional reconfigurations are released by the UE. However, when the intra-SN CPC is executed, the MN currently is not informed, so the MN cannot perform the CHO and/or CPC release/update operation.

### Aspect 1: A Inter-Node Coordinate/Interaction Procedure to Inform the SN about CHO with MR-DC and/or CPC Procedure

The MN informs the SN when CHO with MR-DC and/or CPC procedure is configured/initiated. The MN sends an indication of CHO with MR-DC and/or CPC (e.g., CHO MR-DC Indicator, CPC Data Forwarding indicator) to the SN via an Xn/X2 message, e.g., an XN-U ADDRESS INDICATION message, a DATA FORWARDING ADDRESS INDICATION message or other messages. The indication is to inform that the CHO with MR-DC and/or CPC procedure is configured/initiated (e.g. “CHO MR-DC Indicator” is set to “true”, “CPC Data Forwarding indicator” is set to “triggered”). In one embodiment, the SN may consider that CHO with MR-DC and/or CPC procedure is configured/initiated. In another embodiment, when the SN modifies the SN configuration (e.g. a prepared SN-initiated intra-SN CPC procedure or an RRC reconfiguration using SRB3 has been executed), the SN may inform the MN, and may also send the updated/new SCG configuration to the MN. In another embodiment, the SN may not perform/initiate the SN initiated SN Modification without MN involvement procedure (e.g. an RRC reconfiguration using SRB3).

The MN informs the SN when CHO with MR-DC procedure and/or CPC procedure are canceled/released by the MN or the candidate SN. The MN sends an indication of CHO with MR-DC and/or CPC (e.g., CHO MR-DC Early Data Forwarding Indicator, CPC Data Forwarding indicator) to the SN via an Xn/X2 message, e.g., XN-U ADDRESS INDICATION message, DATA FORWARDING ADDRESS INDICATION message or other messages. The indication is to inform that CHO with MR-DC and/or CPC is canceled (e.g., “CHO MR-DC Early Data Forwarding Indicator” is set to “stop”, “CPC Data Forwarding indicator” is set to “triggered”). In one embodiment, the SN may consider that CHO with MR-DC and/or CPC procedure is canceled/released or not configured. In another embodiment, the SN may perform/initiate the SN initiated SN Modification without MN involvement procedure (e.g. an RRC reconfiguration using SRB3), when the SCG reconfiguration is needed.

The indications above transferred between the MN and the SN can be configured by one of the following options:

Option 1: Include the indication on information element directly in an Xn/X2 message.

Option 2: Include the indication in an RRC message, e.g., CG-Config/CG-ConfigInfo message. The RRC message is included as one information element in an Xn/X2 message.

An example of the indicator about CHO with MR-DC and/or CPC are shown in the following table:

TABLE 1
Examples of signaling structure for the indicator about CHO with MR-DC and/or CPC

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| CHO MR-DC | O | ENUMERATED | Indicating that | YES | reject |
| Indicator | | (true, . . .) | the XN-U | | |
| | | | ADDRESS | | |
| | | | INDICATION | | |
| | | | message is for | | |
| | | | Conditional | | |
| | | | Handover, as | | |
| | | | specified in | | |
| | | | TS 37.340 [8]. | | |
| CHO MR-DC | O | ENUMERATED | | YES | ignore |
| Early Data | | (stop, . . .) | | | |
| Forwarding | | | | | |
| Indicator | | | | | |
| CPC Data | O | ENUMERATED | Indicating that | YES | reject |
| Forwarding | | (triggered, early | the XN-U | | |
| indicator | | data transmission | ADDRESS | | |
| | | stop, . . .) | INDICATION | | |
| | | | message is for | | |
| | | | a Conditional | | |
| | | | PSCell | | |
| | | | Change. | | |

### Aspect 2: A Inter-Node Coordinate/Interaction Procedure to Inform the MN about a Prepared SN-Initiated Intra-SN CPC Procedure and/or an RRC Reconfiguration Using SRB3 has been Executed, and/or the New/Updated SCG Configuration

The SN informs the MN about a prepared SN-initiated intra-SN CPC procedure and/or an RRC reconfiguration using SRB3 has been executed. The MN sends one or more indications via an Xn/X2 message (e.g., S-NODE/SGNB MODIFICATION REQUIRED message). The indication can be at least one of the following:

Option 1: an indication (e.g., “SCG Reconfiguration Notification”, the value may be set as “SN-initiated intra-SN CPC” and/or “RRC Reconfiguration using SRB3”) to indicate that a prepared SN-initiated intra-SN CPC procedure and/or an RRC reconfiguration using SRB3 has been executed.

Option 2: an indication to indicate that the SCG reconfiguration notification is for SN initiated intra-SN CPC procedure or conditional SCG reconfiguration (e.g., “SN initiated intra-SN CPC”, the value may be set to “true” or “executed”)

Option 3: an indication (e.g., “Conditional SCG Reconfiguration Notification”, the value may be set to “executed”) to indicate that a prepared SN-initiated intra-SN CPC procedure has been executed.

Option 4: an indication (e.g., “SCG Reconfiguration Notification”, the value may be set to “executed”) to indicate that an RRC reconfiguration using SRB3 has been executed.

The SN may also send the updated/new SCG configuration to the MN, e.g., including the S-NG-RAN node to M-NG-RAN node Container IE in the S-NODE MODIFICATION REQUIRED message or other messages, or including SgNB to MeNB Container IE in the SGNB MODIFICATION REQUIRED message or other messages. In one embodiment, the MN may consider that a prepared SN-initiated intra-SN CPC procedure and/or an RRC reconfiguration using SRB3 has been executed. In another embodiment, if indication is to indicate that a prepared SN-initiated intra-SN CPC procedure has been executed, the MN may consider that the conditional reconfiguration (e.g., CHO, CPC), if configured in the UE, has been released due to execution of a conditional SCG configuration or execution of intra-SN CPC. In another embodiment, if the SgNB to MeNB Container IE is included in the SGNB MODIFICATION REQUIRED message or if the S-NG-RAN node to M-NG-RAN node Container IE is included in the S-NODE MODIFICATION REQUIRED message, the MN may, if supported, consider that the new SCG configuration has already been applied in the UE and should not be forwarded to the UE. In another embodiment, the MN may initiate/trigger the CHO/CPAC cancellation/release procedure towards the target/candidate node(s) to cancel/release the CHO/CPAC configuration, and/or may initiate/trigger the CHO/CPAC modification procedure towards the target/candidate node(s) to update the candidate cell configuration based on the new SCG configuration. The MN may send the updated/new CHO/CPAC configuration (including the candidate cell configuration and/or the execution condition) to the UE via one or more RRC reconfiguration message.

The indications above transferred between the MN and the SN can be configured by one of the following options:

Option 1: Include the indication on information element directly in an Xn/X2 message.

Option 2: Include the indication in an RRC message, e.g., CG-Config/CG-ConfigInfo message. The RRC message is included as one information element in an Xn/X2 message.

An example of the indicator about SCG reconfiguration execution are shown in the following table:

TABLE 2
Examples of signaling structure for the indicator about SCG reconfiguration execution

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| SCG | ∘ | ENUMERATED | YES | ignore |
| Reconfiguration | | (executed, . . . ) | | |
| Notification | | | | |
| Conditional | ∘ | ENUMERATED | YES | ignore |
| SCG | | (executed, . . . ) | | |
| Reconfiguration | | | | |
| Notification | | | | |
| SCG | ∘ | ENUMERATED | YES | ignore |
| Reconfiguration | | (SN-initiated | | |
| Notification | | intra-SN CPC, | | |
| | | RRC | | |
| | | Reconfiguration | | |
| | | using SRB3, . . . ) | | |
| SN initiated | ∘ | ENUMERATED | YES | ignore |
| intra-SN CPC | | (true/executed, . . . ) | | |

In the paragraphs below, details are provided in some embodiments, but the present disclosure is not limited to these embodiments.

FIG. 4 shows one embodiment of communications for a Master Node (MN) and a Secondary Node (SN). In this embodiment, a CHO with MR-DC procedure is prepared/initiated in case of NR-DC. The procedure is also applicable to other MR-DC cases, e.g., EN-DC. FIG. 4 show the following example steps.

Step 402. The source MN starts the handover procedure by initiating the Xn Handover Preparation procedure including both MCG and SCG configuration. The source MN includes a CHO indicator in the Handover Request message to request the CHO initiation/preparation.

Step 404. If the target MN decides to keep the UE context in source SN, the target MN sends SN Addition Request to the SN including the SN UE XnAP ID as a reference to the UE context in the SN that was established by the source MN. If the target MN decides to change the SN allowing delta configuration, the target MN sends the SN Addition Request to the target SN including the UE context in the source SN that was established by the source MN. Otherwise, the target MN may send the SN Addition Request to the target SN including neither the SN UE XnAP ID nor the UE context in the source SN that was established by the source MN.

Step 406. The (target) SN replies with SN Addition Request Acknowledge. The (target) SN may include the indication of the full or delta RRC configuration. In some embodiments, for CHO with SCG configuration (i.e., CHO with MR-DC), it is up to the target MN implementation to make sure that the CG-Config provided from the (target) SN can be used in all CHO preparations.

Step 408. For SN terminated bearers using MCG resources, the target MN provides Xn-U DL TNL address information in the Xn-U Address Indication message.

Step 410. The target MN includes within the Handover Request Acknowledge message the MN RRC reconfiguration message to be sent to the UE in order to perform the handover, and may also provide forwarding addresses to the source MN.

Step 412. The source MN informs the source SN that the CHO with MR-DC has been configured via Xn-U Address Indication procedure, e.g., including the CHO MR-DC Indicator (the value is set to “true”) in the Xn-U Address Indication message. The source SN, if applicable, starts early data forwarding for SN-terminated bearers, together with the sending of an EARLY STATUS TRANSFER message to the source MN.

Step 414. The MN sends to the UE an RRCReconfiguration message including CHO configuration for candidate cells, i.e., a list of candidate cell configurations and corresponding execution conditions. The candidate cell configuration may include both MCG configuration and SCG configuration.

Step 416. The UE applies the RRCReconfiguration message received in step 414, stores the candidate cell configuration and replies to the MN with an RRCReconfigurationComplete message. In some embodiments, the UE may store the candidate cell configurations for different types of conditional reconfiguration (e.g., CHO, CPA, MN initiated inter-SN CPC, SN initiated inter-SN CPC, SN initiated intra-SN CPC, etc.). The step 402-416 is an example for CHO with MR-DC preparation procedure.

Step 418. The UE starts evaluating the execution conditions. If the execution condition of one candidate cell is satisfied, the UE applies the selected candidate cell configuration and synchronizes to that cell.

Step 420. A prepared SN-initiated intra-SN CPC procedure (e.g., receiving an RRCReconfigurationComplete message for intra-SN CPC execution from the UE) and/or an RRC reconfiguration using SRB3 has been executed within the source SN.

Step 422. The source SN informs the MN about the execution of SCG reconfiguration execution (e.g., an execution of SN initiated intra-SN CPC and/or an RRC reconfiguration using SRB3) via an SN modification required message. The message includes one or more indications (e.g., “SCG Reconfiguration Notification”) to indicate the execution of SCG reconfiguration. The message may also include the updated/new SCG configuration to the MN (e.g., including the S-NG-RAN node to M-NG-RAN node Container IE in the SN modification required message).

Step 424. The MN sends an SN modification confirm message to the source SN. If the indication (e.g., “SCG Reconfiguration Notification”) is received from the source SN, the MN may consider that a prepared SN-initiated intra-SN CPC procedure and/or an RRC reconfiguration using SRB3 has been executed. In some embodiments, if indication is to indicate that a prepared SN-initiated intra-SN CPC procedure has been executed, the MN may consider that the conditional reconfiguration (e.g., CHO, CPC), if configured in the UE, has been released due to execution of a conditional SCG configuration or execution of intra-SN CPC. In some embodiments, if the S-NG-RAN node to M-NG-RAN node Container IE is included in the SN modification required message, the MN may, if supported, consider that the new SCG configuration has already been applied in the UE and should not be forwarded to the UE.

In some embodiments, the MN may initiate/trigger the CHO/CPAC cancellation/release procedure towards the target/candidate node(s) to cancel/release the CHO/CPAC configuration, and/or may initiate/trigger the CHO/CPAC modification procedure towards the target/candidate node(s) to update the candidate cell configuration based on the new SCG configuration. The MN may send the updated/new CHO/CPAC configuration (including the candidate cell configuration and/or the execution condition) to the UE via RRC reconfiguration message.

In some embodiments, in case that any conditional reconfiguration (e.g., CHO, CPA, MN initiated inter-SN CPC, SN initiated inter-SN CPC, SN initiated intra-SN CPC, etc.) is prepared, and if SN initiated intra-SN CPC procedure is executed, the SN may include an indicator (e.g., SCG Reconfiguration Notification) in the SN/SgNB Modification Required message or other messages. The MN considers that a conditional reconfiguration, if configured in the UE, has been released due to execution of a conditional SCG configuration.

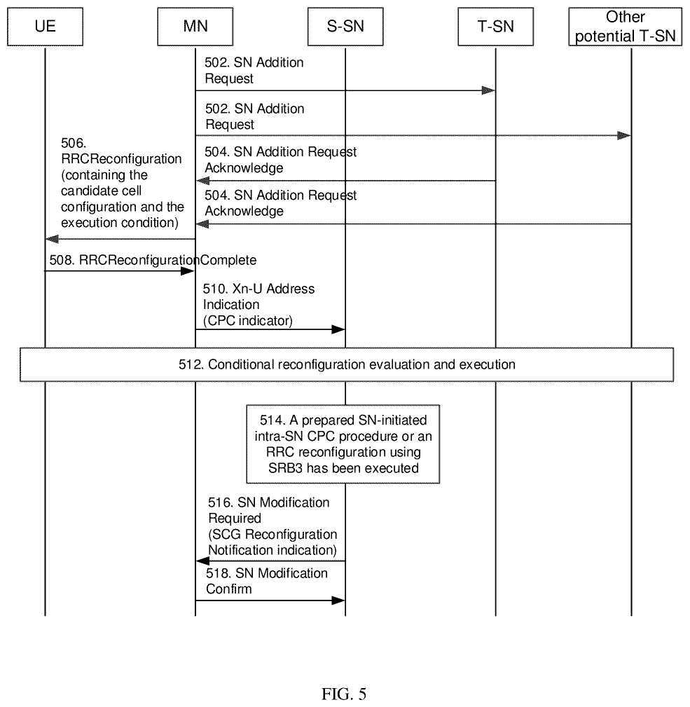

FIG. 5 shows another embodiment of communications for a Master Node (MN) and a Secondary Node (SN). In this embodiment, a CPC procedure is prepared/initiated in case of NR-DC. The procedure is also applicable to other MR-DC cases, e.g., EN-DC. The source SN is denoted as S-SN, and the target SN or the candidate SN is denoted as T-SN and/or other potential T-SNs.

Step 502/504. The MN initiates the conditional SN change by requesting the candidate SN(s) to allocate resources for the UE by means of the SN Addition procedure. The MN sends an SN Addition Request message including an indication to indicate that the request is for CPAC. The MN also provides the candidate cells recommended by MN via the latest measurement results for the candidate SN(s) to choose and configure the SCG cell(s), provides the upper limit for the number of PSCells that can be prepared by the candidate SN. Within the list of cells as indicated within the measurement results indicated by the MN, the candidate SN decides the list of PSCell(s) to prepare (considering the maximum number indicated by the MN) and, for each prepared PSCell, the candidate SN decides other SCG SCells and provides the new corresponding SCG radio resource configuration to the MN in an NR RRCReconfiguration message contained in the SN Addition Request Acknowledge message with the prepared PSCell ID(s). If data forwarding is needed, the candidate SN provides data forwarding addresses to the MN. The candidate SN includes the indication of the full or delta RRC configuration. The candidate SN can either accept or reject each of the candidate cells listed within the measurement results indicated by the MN, i.e., it cannot configure any alternative candidates.

Step 506. The MN sends to the UE an RRCReconfiguration message including CPC configuration for candidate PSCells, i.e., a list of candidate cell configurations and corresponding execution conditions.

Step 508. The UE applies the RRCReconfiguration message received in step 506, stores the candidate cell configuration and replies to the MN with an RRCReconfigurationComplete message. In some embodiments, the UE may store the candidate cell configurations for different types of conditional reconfiguration (e.g., CHO, CPA, MN initiated inter-SN CPC, SN initiated inter-SN CPC, SN initiated intra-SN CPC, etc.). The step 502-508 is an example for MN initiated inter-SN CPC preparation procedure.

Step 510. Upon receiving the MN RRCReconfigurationComplete message from the UE, the MN informs the source SN that the CPC has been configured via Xn-U Address Indication procedure, e.g., including the CPC Data Forwarding indicator (the value is set to “triggered”) in the Xn-U Address Indication message. The source SN, if applicable, together with the Early Status Transfer procedure, starts early data forwarding. The PDCP SDU forwarding may take place during early data forwarding.

Step 512. The UE starts evaluating the execution conditions. If the execution condition of one candidate PSCell is satisfied, the UE applies the selected candidate PSCell configuration and synchronizes to that PSCell.

Step 514. A prepared SN-initiated intra-SN CPC procedure (e.g., receiving an RRCReconfigurationComplete message for intra-SN CPC execution from the UE) or an RRC reconfiguration using SRB3 has been executed within the source SN.

Step 516. The source SN informs the MN about the execution of SCG reconfiguration execution (e.g., an execution of SN initiated intra-SN CPC and/or an RRC reconfiguration using SRB3) via an SN modification required message. The message includes one or more indications (e.g., “SCG Reconfiguration Notification”) to indicate the execution of SCG reconfiguration. The message may also include the updated/new SCG configuration to the MN (e.g., including the S-NG-RAN node to M-NG-RAN node Container IE in the SN modification required message).

Step 518. The MN sends an SN modification confirm message to the source SN. If the indication (e.g., “SCG Reconfiguration Notification”) is received from the source SN, the MN may consider that a prepared SN-initiated intra-SN CPC procedure and/or an RRC reconfiguration using SRB3 has been executed. In some embodiments. If indication is to indicate that a prepared SN-initiated intra-SN CPC procedure has been executed, the MN may consider that the conditional reconfiguration (e.g., CHO, CPC), if any configured in the UE, has been released due to execution of a conditional SCG configuration or execution of intra-SN CPC. In some embodiments, if the S-NG-RAN node to M-NG-RAN node Container IE is included in the SN modification required message, the MN may, if supported, consider that the new SCG configuration has already been applied in the UE and should not be forwarded to the UE.

In some embodiments, the MN may initiate/trigger the CHO/CPAC cancellation/release procedure towards the target/candidate node(s) to cancel/release the CHO/CPAC configuration, and/or may initiate/trigger the CHO/CPAC modification procedure towards the target/candidate node(s) to update the candidate cell configuration based on the new SCG configuration. The MN may send the updated/new CHO/CPAC configuration (including the candidate cell configuration and/or the execution condition) to the UE via RRC reconfiguration message.

In some embodiments, in case that any conditional reconfiguration (e.g., CHO, CPA, MN initiated inter-SN CPC, SN initiated inter-SN CPC, SN initiated intra-SN CPC, etc.) is prepared, and if SN initiated intra-SN CPC procedure is executed, the SN may include an indicator (e.g., SCG Reconfiguration Notification) in the SN/SgNB Modification Required message or other messages. The MN considers that a conditional reconfiguration, if any configured in the UE, has been released due to execution of a conditional SCG configuration.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random-Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software-based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
sending by a secondary wireless communication node (SN) to a master wireless communication node (MN) a request message comprising an indication of an execution of a Secondary Cell Group (SCG) reconfiguration by the SN and an SCG configuration contained in an SN to MN container information element (IE), wherein the request message causes the MN to treat the SCG configuration as having already been applied in a user equipment (UE) and not to forward the SCG configuration to the UE; and
receiving by the SN from the MN a response message associated with the request message.

2. (canceled)

3. The method of claim 1, wherein the request message comprises an SN modification required message, and wherein the response message comprises an SN modification confirm message.

4. (canceled)

5. (canceled)

6. The method of claim 1, wherein the execution of SCG reconfiguration comprises at least one of:
an execution of an SN initiated intra-SN conditional PSCell change (CPC) procedure; or
an execution of an RRC reconfiguration using signaling radio bearer 3 (SRB3).

7. The method of claim 6, wherein the execution of the SN initiated intra-SN CPC causes the MN to consider that a conditional reconfiguration, if configured in the UE, has been released due to execution of the SN initiated intra-SN CPC.

8. The method of claim 7, wherein the conditional reconfiguration comprises at least one of the following:
a conditional handover (CHO); or
an MN initiated conditional PSCell change (CPC).

9. A method for wireless communication, comprising:
receiving from a secondary wireless communication node (SN) by a master wireless communication node (MN) a request message comprising an indication of an execution of Secondary Cell Group (SCG) reconfiguration by the SN and an SCG configuration contained in an SN to MN container information element (IE);
treating the SCG configuration as having already been applied in a user equipment (UE) and not forwarding the SCG configuration to the UE; and
transmitting by the MN to the SN a response message associated with the request message.

10. (canceled)

11. The method of claim 9, wherein the request message comprises an SN modification required message, and wherein the response message comprises an SN modification confirm message.

12. (canceled)

13. (canceled)

14. The method of claim 9, wherein the execution of SCG reconfiguration comprises at least one of:
an execution of an SN initiated intra-SN conditional PSCell change (CPC) procedure; or
an execution of an RRC reconfiguration using signaling radio bearer 3 (SRB3).

15. The method of claim 14, wherein the execution of the SN initiated intra-SN CPC causes the MN to consider that a conditional reconfiguration, if configured in the UE, has been released due to execution of the SN initiated intra-SN CPC.

16. The method of claim 15, wherein the conditional reconfiguration comprises at least one of the following:
a conditional handover (CHO); or
an MN initiated conditional PSCell change (CPC).

17. A secondary wireless communication node (SN) comprising a memory for storing instructions and at least one processor configured to execute the instructions to:
send to a master wireless communication node (MN) a request message comprising an indication of an execution of a Secondary Cell Group (SCG) reconfiguration by the SN and an SCG configuration contained in an SN to MN container information element (IE), wherein the request message causes the MN to treat the SCG configuration as having already been applied in a user equipment (UE) and not to forward the SCG configuration to the UE; and
receive from the MN a response message associated with the request message.

18. (canceled)

19. The SN of claim 17, wherein the request message comprises an SN modification required message, and wherein the response message comprises an SN modification confirm message.

20. The SN of claim 17, wherein the execution of SCG reconfiguration comprises at least one of:
an execution of an SN initiated intra-SN conditional PSCell change (CPC) procedure; or
an execution of an RRC reconfiguration using signaling radio bearer 3 (SRB3).

21. The SN of claim 20, wherein the execution of the SN initiated intra-SN CPC causes the MN to consider that a conditional reconfiguration, if configured in the UE, has been released due to execution of the SN initiated intra-SN CPC.

22. The SN of claim 21, wherein the conditional reconfiguration comprises at least one of the following:
a conditional handover (CHO); or
an MN initiated conditional PSCell change (CPC).

23. A master wireless communication node (MN) comprising a memory for storing instructions and at least one processor configured to execute the instructions to:
receive from a secondary wireless communication node (SN) a request message comprising an indication of an execution of Secondary Cell Group (SCG) reconfiguration by the SN and an SCG configuration contained in an SN to MN container information element (IE);
treat the SCG configuration as having already been applied in a user equipment (UE) and not forwarding the SCG configuration to the UE; and
transmit to the SN a response message associated with the request message.

24. The MN of claim 23, wherein the request message comprises an SN modification required message, and wherein the response message comprises an SN modification confirm message.

25. The MN of claim 23, wherein the execution of SCG reconfiguration comprises at least one of:
an execution of an SN initiated intra-SN conditional PSCell change (CPC) procedure; or
an execution of an RRC reconfiguration using signaling radio bearer 3 (SRB3).

26. The MN of claim 25, wherein the execution of the SN initiated intra-SN CPC causes the MN to consider that a conditional reconfiguration, if configured in the UE, has been released due to execution of the SN initiated intra-SN CPC.

27. The MN of claim 26, wherein the conditional reconfiguration comprises at least one of the following:
a conditional handover (CHO); or
an MN initiated conditional PSCell change (CPC).
